(19) United States
(12) Patent Application Publication
(10) Pub. No.: US 2014/0367456 A1
(43) Pub. Date: Dec. 18, 2014

(54) POLYOLEFIN AND CELLULOSE LAMINATE FOR FOOD AND BEVERAGE CONTAINERS

(71) Applicant: Kolm Polymers, Ltd., The Woodlands, TX (US)

(72) Inventor: Gary D. JERDEE, The Woodlands, TX (US)

(21) Appl. No.: 14/305,944

(22) Filed: Jun. 16, 2014

Related U.S. Application Data
(60) Provisional application No. 61/835,344, filed on Jun. 14, 2013.

(51) Int. Cl. B65D 3/22; D21H 23/22

(52) U.S. Cl. CPC B65D 3/22; D21H 23/22; B29K 2023/0633
USPC 229/5.81; 427/411

(57) ABSTRACT

A method and apparatus for in one implementation, a rigid paperboard container, the container being constructed from extrusion coated or laminated paperboard is provided. The rigid paperboard container comprises (a) a paperboard substrate having opposed inner and outer surfaces, (b) a first polymer layer coated or laminated onto the outer surface of the paperboard substrate, the first polymer layer comprising (i) metallocene catalyzed polyethylene polymer and (ii) optionally LDPE, (c) a second polymer layer coated or laminated over the first polymer layer, the second polymer layer comprising (i) metallocene catalyzed polyethylene polymer and (ii) LDPE and (d) a third polymer layer coated or laminated over the second polymer layer, the third polymer layer comprising (i) metallocene catalyzed polyethylene polymer and (ii) optionally low density polyethylene polymer (LDPE).

### CROSS-REFERENCE TO RELATED APPLICATIONS

This application claims benefit of U.S. provisional patent application Ser. No. 61/835,344, filed Jun. 14, 2013.

### BACKGROUND

1. Field

Implementations described herein generally relate to products and methods for producing the products for use in packaging and beverages. More specifically, implementations described herein relate to products and methods for producing the products using metallocene polyethylene (mPE) resins in co-extrusion processes to produce laminates containing metallocene catalyzed polyethylene polymers.

2. Description of the Related Art

Single use cellulose and polymer laminated containers for packaging food and beverages provide a multi-use material used to make economical containers. Said containers are commonly referred to as cupstock, liquid packaging, and folding carton stock and typically have varying paper thickness with polyethylene coatings on one or both sides depending on their end use.

Cellulose substrates coated with polyethylene on both sides are used for cold drinks and refrigerated products. These cellulose substrates require complete protection of the cellulose fibers from moisture that forms due to condensate build-up. Condensate forms when the cup temperature falls below the dew point of the cup's environment. Higher humidity regions tend to be the highest consumers of cold cups made from polymer coated cellulose. Improving the seal strength of cold cups affords substantial potential financial gain for a cup manufacturer. If left unprotected the cellulose will absorb moisture and turn to pulp losing the strength the cellulose had as a dry substrate.

Frozen or refrigerated food content serves as a heat sink and keeps the packaging material below the flash point of the cellulose and the vicat (softening temperature) and the melting point of the polymeric portion(s) of the packaging materials. However, the containers used for beverages and food products served hot, such as hot coffee, tea, and soups containers present unique thermal challenges that must be managed. Dual oven-able and microwavable containers made from plastic and paper raw materials can withstand temperatures beyond their melting temperatures for limited time periods. Time and temperature instructions are set to remove the package from the heat source at the precise moment when the contents and package reach equilibrium near the desired serving temperature.

A package designer must consider the entire lifecycle of a cellulose and polymer laminate for every individual application. On one end of the spectrum every beverage or food product has different shelf life requirements, different product moisture and oxygen barrier requirements that must be met. The lifecycle is a function of the thickness and type of polymers in the laminate.

A laminate is typically a multi-layer composite substrate. Often one or more laminates are roll or sheet fed into a forming machine. Often a lid and or bottom stock with different calipers and coatings can be fed into the formers. The substrates are formed and sealed into cups or round and rectangular shaped containers at rates of 300 per minute and greater.

The complexity of a container ranges from 100% cellulose held together with adhesive's to multi-layer extrudates coated on both sides and used to adhere secondary film's that are also multi-layered including their own sealant surface. The barrier properties of a package also depend on achieving a 100% hermetic seal in all seal areas. Seal strength typically depends on the polymer type, polymer density and sealing conditions. Polyethylene is often the polymer material of choice.

Polyethylene was discovered in 1933 by scientists at Imperial Chemical Industries. Initially polyethylene served as a lab curiosity until its use as an electrical insulator material and radar component were eventually discovered. The polyethylene fabrication process was known as high pressure or autoclave reactors. By 1940 two companies were producing high pressure autoclave polyethylene in the United States. Due to wartime allocations it took 12 years for polyethylene samples to become available for experimental packaging development.

From 1945 to 1956 the DuPont Chemical Company worked closely with a number of paper companies including H. P. Smith, St. Regis, International Paper, and Sealright Company to experimentally coat light weight paper and paperboard with polyethylene. The Hartig Engine and Machine Company and Frank W. Egan Company developed the first commercial extrusion coating lines.

St. Regis was credited with the first commercial coating line to use extruders and a slotted type die. In 1957, DuPont, Egan and Sealright produced the very first milk carton from polyethylene coated paperboard. The entire process was developed for a single resin type “autoclave polyethylene”.

The breakthrough into the paper milk container industry resulted in the immediate phenomenal growth of polyethylene resin, and in 1955 polyethylene resin became the first billion pound resin manufactured in the United States. By 1960 single service milk container manufacturers had converted from paraffin wax to polyethylene coating and 90 million pounds of polyethylene were produced. In 1970, 220 million pounds of polyethylene was consumed for paperboard coating alone.

Currently, four high pressure autoclave low density polyethylene resins (LDPE) comprise most of the extrusion coating polyethylene volume of the over one billion pounds of LDPE produced annually in North America. Further, about half of the Paper and Paperboard end-use markets all use a single autoclave resin with a melt index of around 5 grams/10 min and a density of about 0.923 grams/cc. The Autoclave Reactor and associated manufacturing process have stood the test of time. The resultant polymer exhibits a broad molecular weight distribution creating a resin that processes very well on a flat die. Process conditions control the molecular weight which is inversely related to the melt index. However, the flaw in the autoclave process is an undesirable low molecular weight portion that cannot be separated from the finished product. The polymer exits the reactor in a molten form where it is stored in a steam heated vessel prior to final finishing through extruders and underwater pelletizers. In a molten state and common heated storage vessel the aggregate polymer becomes coated with molten paraffin and oligomers prior to being solidified through a water cooled pelletizing unit. The inability to isolate and remove these low molecular weight molecules limits the process temperature in the extrusion coating process.

The undesirable short chain polymer molecules entrained in the aggregate polymers' molecular weight distribution can cause quality problems from oxidation by-products. Gels, negative organoleptic properties, such as degraded food flavor, and package odor can all be negatively compromised by polymers produced by the current autoclave manufacturing process. There are many food products and beverages that are packaged in glass, metal, and polyester containers because their flavor, taste, and odor is negatively impacted by the oligomers retained in autoclave resins.

Therefore, there is a need for stronger containers and methods for producing said containers that have improved physical properties such as organoleptic, moisture barrier, gloss, and heat seal properties without increasing the cost structure.

### SUMMARY

Implementations described herein generally relate to products and methods for producing the products for use in packaging and beverages. More specifically, implementations described herein relate to products and methods for producing the products using metallocene polyethylene (mPE) resins in co-extrusion processes to produce laminates containing metallocene catalyzed polyethylene polymers.

In one implementation, a rigid paperboard container, the container being constructed from extrusion coated or laminated paperboard is provided. The rigid paperboard container comprises (a) a paperboard substrate having opposed inner and outer surfaces, (b) a first polymer layer coated or laminated onto the outer surface of the paperboard substrate, the first polymer layer comprising (i) metallocene catalyzed polyethylene polymer and (ii) optionally LDPE.

In another implementation, a rigid paperboard container, the container being constructed from extrusion coated or laminated paperboard is provided. The rigid paperboard container comprises (a) a paperboard substrate having opposed inner and outer surfaces, (b) a first polymer layer coated or laminated onto the outer surface of the paperboard substrate, the first polymer layer comprising (i) metallocene catalyzed polyethylene polymer and (ii) optionally LDPE, (c) a second polymer layer coated or laminated over the first polymer layer, the second polymer layer comprising (i) metallocene catalyzed polyethylene polymer and (ii) LDPE and (d) a third polymer layer coated or laminated over the second polymer layer, the third polymer layer comprising (i) metallocene catalyzed polyethylene polymer and (ii) optionally low density polyethylene polymer (LDPE).

In another implementation, a method of producing a rigid paperboard container wherein the polymer layers are produced using a coextrusion process including the use of metallocene polyethylene resins is provided.

In yet another implementation, a method of making a rigid paperboard container is provided. The method comprises providing a paperboard substrate having opposed inner and outer surfaces and depositing a first polymer layer onto the outer surface of the paperboard substrate. The first polymer layer comprises a metallocene catalyzed polyethylene polymer and optionally low density polyethylene (LDPE). The method may further comprise depositing a second polymer layer onto the first polymer layer. The second polymer layer may comprise i) the metallocene catalyzed polyethylene polymer and ii) the LDPE. A third polymer layer may be deposited onto the second polymer layer. The third polymer layer may comprise i) the metallocene catalyzed polyethylene polymer and ii) optionally the LDPE. A fourth polymer layer may be deposited onto the inner surface of the paperboard substrate. The fourth polymer layer may comprise i) the metallocene catalyzed polyethylene polymer and ii) optionally the LDPE. A fifth polymer layer may be deposited over the fourth polymer layer. The fifth polymer layer may comprise i) the metallocene catalyzed polyethylene polymer and ii) optionally the LDPE. A sixth polymer layer may be deposited over the fifth polymer layer. The sixth polymer layer may comprise i) the metallocene catalyzed polyethylene polymer and optionally the LDPE.

In yet another implementation, laminates with ten to 15 layers are possible in a single pass on a tandem coextrusion coating line. Current technology for most cup stock and similar single service use products consists of a single layer of autoclave LDPE extruded onto SBS board stock. Blends or coextrusions of LLDPE have been incorporated for seal strength enhancement but bring both commercial issues and technical problems. In particular LLDPE tend to die cut poorly and small threads of polymer can separate from the laminate stock. Keeping the rotary die cutting knives in a sharp state can eliminate the problem.

In some implementations, coating weights are 0.75 mil and 0.5 mils on the inside and outside of a cup respectively depending whether a cup is used in a hot or cold cup application.

In some implementations, conventional single layers are replaced with a multi-layer coextrusion comprised of one to seven layers.

In some implementations, a two or three layer coextrusion is provided.

In some implementations, metallocene polyethylene resins are used in place of conventional autoclave LDPE.

In some implementations, a three layer coextrusion comprised of 1 to 100% of a preferred metallocene resin in any layer is provided. In some implementations, the outer layer may comprise from about 0.5% to 20% metallocene resin. In some implementations, the inner layer comprises from about 10% to 90% of metallocene resin. In some implementations, the inner layer comprises from about 60% to about 90%.

### BRIEF DESCRIPTION OF THE DRAWINGS

So that the manner in which the above-recited features of the present disclosure can be understood in detail, a more particular description of the disclosure, briefly summarized above, may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

FIG. 1 is a cross-section of a paperboard container according to implementations of the present disclosure;

FIG. 2 is a plot depicting the change in seal force as temperature increases for a heat seal of 100% LDPE verses a heat seal produced according to the present disclosure (50% BDM2 13-02);

FIG. 3 is another plot depicting the change in seal force as temperature increases for a heat seal composed of LDPE verses a heat seal produced according to the present disclosure;

FIG. 4 is another plot depicting differential scanning calorimetry results for a commercially available extrusion coating grade LDPE in comparison with the resin of the present disclosure;

FIG. 5 is another plot depicting the change in seal force as temperature increases for a heat seals composed of commercially available LDPE resins verses a heat seal produced according to the present disclosure; and

FIG. 6 is another plot depicting the gel permeation chromatography (GPC) molecular weight results a commercially available extrusion coating grade LDPE in comparison with the resin of the present disclosure.

To facilitate understanding, identical reference numerals have been used, where possible, to designate identical elements that are common to the figures. It is contemplated that elements disclosed in one implementation may be beneficially utilized in other implementations without specific recitation.

### DETAILED DESCRIPTION

Implementations described herein generally relate to products and methods for producing the products for use in packaging and beverages. More specifically, implementations described herein relate to products and methods using new metallocene polyethylene (mPE) resins and metallocene catalyzed polyethylene polymers with coextrusion processes.

As used herein, the term “substrate” refers to a layer of material that serves as a basis for subsequent processing operations as described herein. A non-limiting list of “substrates” includes woven fibers, non-woven fibers, polymeric substrates, metallic substrates (e.g., foil), and cellulose substrates.

The polyethylene's used herein are metallocene polyethylenes, i.e. they have been produced using a metallocene-based catalyst system, which comprises a metallocene, optionally a support and a co-catalyst. Exemplary mPEs that may be used with the implementations described herein include but are not limited to a metallocene polyethylene resins available from Total Petrochemicals under the tradename LUMICENE®.

Unlike currently produced autoclave LDPE the new material is far less susceptive to thermal degradation. Process temperatures can be increased to improve adhesion without causing odor or heat seal problems associated with excess oxidation. Tailored molecular weight distribution eliminates low molecular weight paraffin fractions known to cause organoleptic problems. Superior seal strength and physical strength properties allow for potential downgauging and material savings. Drawdown and neck-in are not compromised with the tailored molecular weight distribution.

The dominant processes and resins currently used to manufacture most commercial cups and cartons is autoclave low density polyethylene (“LDPE”) which involves free radical polymerization of ethylene, with or without the presence of co-monomers. LDPE with densities ranging from 0.921 to 0.924 g/cm³ and melt indexes from 4.0 to 8.0 g/10 minutes are typically used in current hot and cold content containers. The LDPE made by the autoclave reactor process has a high concentration of long chain branches that makes it easy to process. However, the autoclave reactor process does not allow for the removal of the low molecular paraffin portion of the polymer. This low molecular weight tail is the source of autoclave polymers negative organoleptic properties.

The slurry loop process technology described herein prevents low molecular weight length fractions from forming in the process, enhancing the final products ability to not degrade thermally through the use of antioxidant additive technology. The BDM2 13-02 polymer has 100 times the ability to withstand thermal degradation than barefoot extrusion coating grade autoclave polymers. This property allows higher process melt temperatures to be run. The higher melt temperatures generate a lower viscosity extrudate and improve the polymers adhesion to fiber substrates without compromising the slurry loop polymers organoleptic properties.

Further, current containers made using the LDPE autoclave process often suffer from over-oxidation of the polyethylene coating, leading to poor heat seals, a high number of cosmetic defects such as poor cup rim formations known as flaggers, or bottom seals known as blisters, which lead to a high QC rejection rate.

The metallocene may be supported according to any method known in the art. In the event it is supported, the support used in the implementations of the present disclosure can be any organic or inorganic solid, particularly porous supports such as talc, inorganic oxides, and resinous support material such as polyolefin. Anti-oxidant additives are considered necessary to maintain the quality of the metallocene polymer in its initial polymerization process, plus the heat history it is subject to in a subsequent converting process. Anti-oxidants work against a successful adhesion to a cellulose substrate and therefore were modified to a level considered necessary to use the preferred metallocene successfully in this application.

Some implementations described herein provide containers and methods for producing said containers that have improved physical properties without dramatically increasing the cost structure. The advent of specialty metallocene polyethylene resins with targeted variable densities allows for stronger heat seals, increased thermal resistance and improved moisture vapor transmission rate (“MVTR”) properties simultaneously. Heretofore unavailable, this new polymer technology creates stronger containers with highly desired increased heat resistance and improved MVTR barrier properties. This new polymer technology combines the benefits of slurry loop linear polymers, the processability characteristics of autoclave high pressure resins and autoclave like melt strength properties and the superior enhanced properties of metallocene single site catalysts. Made from a low pressure manufacturing process, the new resin can be introduced while maintaining or even decreasing the package raw material costs.

Some implementations described herein may be used for cold beverage cups and hot beverage cups. One exemplary container is a cup designed for hot liquids such as coffee. Stronger cups having increased heat resistance are described herein. These cups have fewer defects than the current cups produced using autoclave LDPE only cups. The top rim of the cups described herein far exceeds the strength of the LDPE only cup and is expected to dramatically reduce hot coffee cup failure modes seen in bottom and side seam failures when exposed to hot coffee.

A non-limiting list of products that may be produced using the processes described herein include but are not limited to cup stock, folding carton, single use, single serve, food and beverage packaging, multi-wall bags, institutional food packaging, frozen food bags, aseptic packaging laminates, and containers.

The metallocene polyethylene resins described herein may be combined with advanced coextrusion technology to produce superior packages and containers. In some implementations, the heat resistance properties of the packages and containers may be tailored to add additional heat resistance where desired. More specifically coatings and films that are further above the boiling point of water than the existing 110-112 degrees Celsius melt point of the currently available LDPEs may be produced using the implementations described herein.

Like traditional autoclave LDPE resins these slurry loop metallocene resins are uniquely qualified to process in the extrusion coating process. The 2nd Generation mPE polymers sold under the tradename LUMICENE® from Total Petrochemicals were specifically formulated to adhere to cellulose substrates. The mPE resins have a molecular weight distribution tailored to perform in 100:1 drawdown ratio's in flat dies with unsupported edges. Unlike traditional linear polyethylene's produced on slurry loop reactors, these second generation mPE polymers are reacted with long chain branching melt strength properties that appear to be typically associated with autoclave resins. The mPE resin has outstanding clarity, gel's level that are almost non-existent, and most important machine direction and cross machine direction extrudate stability when used in a flat die with unsupported edges not exhibited by low pressure reacted polymers since their inception.

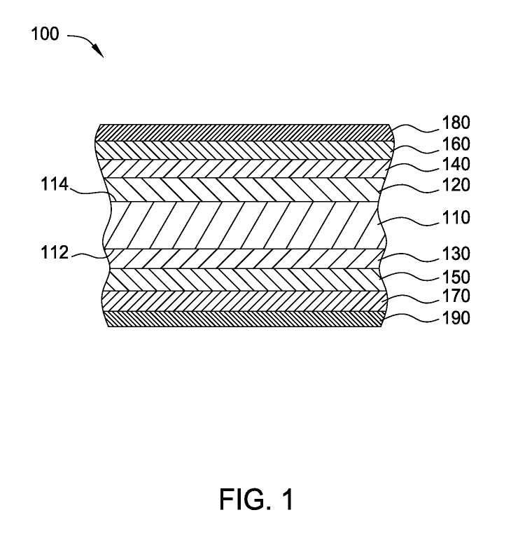

FIG. 1 is a cross-section of a paperboard container 100 according to implementations of the present disclosure. In some implementations, the paperboard container 100 is a rigid paperboard container which is constructed from extrusion coated or laminated paperboard. The paperboard container 100 includes a paperboard substrate 110 with opposed inner 112 and outer surfaces 114, the inner surface 112 being the side of the paperboard substrate 110 which has contact with the air inside the container and the outer surface 114 being the side of the paperboard substrate 110 which has contact with the air outside the container.

In some implementations, the outer surface 114 of the paperboard substrate 110 is coated or laminated with at least one polymer layer 120 comprising at least one metallocene catalyzed polyethylene polymer layer as described herein. The at least one polymer layer 120 may further comprise at least one of: low density polyethylene (LDPE) polymer, linear low density polyethylene (LLDPE) polymer, blends of LDPE and LLDPE polymers, and coextrusions of LDPE and LLDPE. The polymer layer 120 may comprise coextrusions of LDPE and the metallocene catalyzed polyethylene polymer.

In some implementations where the outer surface 114 of the paperboard substrate 110 is coated or laminated with at least one polymer layer 120 comprising at least one metallocene catalyzed polyethylene polymer layer, the inner surface 112 of the paperboard substrate 110 is coated or laminated with at least one polymer layer 130. The polymer layer 130 can be low density polyethylene polymer (LDPE), linear low density polyethylene polymer (LLDPE), a blend of low density polyethylene polymer and linear low density polyethylene polymer, or a coextrusion of low density polyethylene polymer and linear low density polyethylene polymer.

In some implementations, both the at least one polymer layer 120 on the outer surface 114 and the at least one polymer layer 130 on the inner surface 112 of the paperboard substrate 110 comprises the at least one metallocene catalyzed polyethylene polymer layer. The at least one polymer layer 120 and the at least one polymer layer 130 may each independently further comprise at least one of: low density polyethylene (LDPE) polymer, linear low density polyethylene (LLDPE) polymer, blends of LDPE and LLDPE polymers, and coextrusions of LDPE and LLDPE. The at least one polymer layer 120 and the at least one polymer layer 130 may each independently comprise coextrusions of LDPE and the metallocene catalyzed polyethylene polymer.

In some implementations, the inner surface 112 and the outer surface 114 of the paperboard substrate 110 may each independently have at least one adhesive tie layer (not shown) adjacent to the at least one polymer layer 120 and the at least one polymer layer 130. The adhesive tie layer may be positioned between the paperboard substrate 110 and the at least one polymer layer 120. The adhesive tie layer may be positioned between the paperboard substrate 110 and the at least one polymer layer 130.

Adhesive tie layers may be made of various polymeric adhesives, especially anhydride grafted polymers, copolymers or terpolymers as well as maleic anhydride and rubber modified polymers. In another implementation, an adhesive tie layer is juxtaposed between the paperboard substrate 110 and the polymer layer 130 coated or laminated onto the inner surface 112 of the paperboard substrate. In another implementation of the tie layer, the materials used are ionomers, specifically zinc ionomers or sodium ionomers. In another implementation, the tie layer of the inner, product contact, sandwich layer comprises ethylene acrylic acid. In another implementation, the tie layer of the inner product contact sandwich layer comprises ethylene methacrylic acid. Should the need for an oxygen barrier become a priority, the anhydride grafted polymers become more necessary to adhere polyolefin polymers to EVOH and Nylon. EVOH and Nylon are the dominant extrudable oxygen barrier resins used in this process. Aqueous vinylidene chloride (PVdC) oxygen barrier material can be applied to a fibrous or polymeric film and coated or laminated for end use requiring a high oxygen barrier.

In some implementations, a second polymer layer 140, 150 is coated or laminated over at least one of the outer surface 114 and the inner surface 112 of the paperboard substrate 110. As shown in FIG. 1, the second polymer layer 140 may be coated or laminated onto the at least one polymer layer 120. The second polymer layer 150 may be coated or laminated onto the al least one polymer layer 130. Each second polymer layer 140, 150 may independently comprise the at least one metallocene catalyzed polyethylene polymer. Each second polymer layer 140, 150 may further independently comprise at least one of: low density polyethylene (LDPE) polymer, linear low density polyethylene (LLDPE) polymer, blends of LDPE and LLDPE polymers, and coextrusions of LDPE and LLDPE. Each second polymer layer 140, 150 may independently comprise coextrusions of LDPE and the metallocene catalyzed polyethylene polymer.

In yet another implementation, a third polymer layer 160, 170 is coated or laminated over at least one of the outer surface 114 and the inner surface 112 of the paperboard substrate 110. As shown in FIG. 1, the third polymer layer 160 may be coated or laminated onto the second polymer layer 140. The third polymer layer 170 may be coated or laminated onto the second polymer layer 150. Each third polymer layer 160 may independently comprise the at least one metallocene catalyzed polyethylene polymer. Each third polymer layer 160, 170 may further independently comprise at least one of: low density polyethylene (LDPE) polymer, linear low density polyethylene (LLDPE) polymer, blends of LDPE and LLDPE polymers, and coextrusions of LDPE and LLDPE. Each of the third polymer layer 160, 170 may independently comprise coextrusions of LDPE and the metallocene catalyzed polyethylene polymer.

In still another implementation, a fourth polymer layer 180, 190 is coated or laminated over at least one of the outer surface 114 and the inner surface 112 of the paperboard substrate 110. As shown in FIG. 1, the fourth polymer layer 180 may be coated or laminated onto the third polymer layer 160. The fourth polymer layer 190 may be coated or laminated onto the third polymer layer 170. Each fourth polymer layer 180 may independently comprise the at least one metallocene catalyzed polyethylene polymer. Each fourth polymer layer 180, 190 may further independently comprise at least one of: low density polyethylene (LDPE) polymer, linear low density polyethylene (LLDPE) polymer, blends of LDPE and LLDPE polymers, and coextrusions of LDPE and LLDPE. Each of the fourth polymer layer 180, 190 may independently comprise coextrusions of LDPE and the metallocene catalyzed polyethylene polymer. The LPDE described herein may be high pressure LPDE (“HPLDE”)

The first polymer layers 120, 130 and the third polymer layers 160, 170 may each individually comprise from about 1% to about 100% blend composition percent of the metallocene catalyzed polyethylene polymer and from about 0 to 99% blend composition percent of the LDPE. The first polymer layers 120, 130 and the third polymer layers 160, 170 may each individually comprise from about 70% to about 90% blend composition percent of the metallocene catalyzed polyethylene polymer and from about 10% to about 30% blend composition percent of the LDPE.

The second polymer layers 140, 150 may each individually comprise from about 1% to about 99% blend composition percent of the metallocene catalyzed polyethylene polymer and from about 1% to about 99% blend composition percent of the LDPE. The second polymer layers 140, 150 may each individually comprise from about 50% to about 80% blend composition percent of the metallocene catalyzed polyethylene polymer and from about 20% to about 50% blend composition percent of the LDPE.

It should be understood that although four polymer layers are shown on both the inner surface 112 and the outer surface 114 of the paperboard substrate 110, more than four polymer layers may be used or less than four polymer layers may be used with the implementations described herein.

If the at least one metallocene catalyzed polyethylene polymer is used in such a polymer coated paperboard substrate material, formulation design may include, but not be limited to, coated substrate materials with the following structures:

(1) Polymer Coating Layer (mPE/optional LDPE)/Paperboard Substrate

(2) Polymer Coating Layer (mPE/optional LDPE)/Paperboard Substrate/Polymer Coating Layer (mPE/optional LDPE) (3) (B) Polymer Coating Layer (mPE/optional LDPE)/(A) Polymer Coating Layer (mPE/optional LDPE)/(B) Polymer Coating Layer (mPE/optional LDPE)/Paperboard Substrate

(4) (B) Polymer Coating Layer (mPE/optional LDPE)/(A) Polymer Coating Layer (mPE/optional LDPE)/(B) Polymer Coating Layer (mPE/optional LDPE)/Paperboard Substrate/(B) Polymer Coating Layer (mPE/optional LDPE)/(A) Polymer Coating Layer (mPE/optional LDPE)/(B) Polymer Coating Layer (mPE/optional LDPE)

(5) A) Polymer Coating Layer (mPE/optional LDPE)/(A) Polymer Coating Layer (mPE/optional LDPE)/(A) Polymer Coating Layer (mPE/optional LDPE)/Paperboard Substrate

(6) A) Polymer Coating Layer (mPE/optional LDPE)/(A) Polymer Coating Layer (mPE/optional LDPE)/(A) Polymer Coating Layer (mPE/optional LDPE)/Paperboard Substrate/A) Polymer Coating Layer (mPE/optional LDPE)/(A) Polymer Coating Layer (mPE/optional LDPE)/(A) Polymer Coating Layer (mPE/optional LDPE)

### EXAMPLES

The following non-limiting examples are provided to further illustrate implementations described herein. However, the examples are not intended to be all inclusive and are not intended to limit the scope of the implementations described herein.

Heat sealing of polymer extrusion coated board cellulose substrates was performed using open flame activation unlike an all polymer substrate. Film substrates were activated using the variables of time, temperature, pressure, and dwell time to form a seal using sealing bars. Often the heat to melt or activate the sealant side of a web has to be transferred through the film laminate. The sealing bars close and maintain a precise pressure for a preset time. To perfect a seal the heats are elevated as the dwell time is decreased to keep up with production rates.

A traditional film seal can be separated and then peeled slowly apart allowing for a measurement of the seal strength using an Instron test instrument with strain gauges and load cells.

The density of the polymer determines the melt point of LDPE resin. The average melting point for most cup stock LDPE is 110 degrees Celsius to 112 degrees Celsius. This is the Achilles heel for hot cup stock.

There is very little margin of safety when the coffee get's too hot. LDPE has a vicat softening temperature roughly 10 degrees Celsius below the actual melting point. The bottom, side, and top seals of the cup will soften and then fail if the coating thickness is thin. This can happen when a cup is made. The cup former will actually squeeze out the LDPE polymer in the seal area making it vulnerable for failure.

Open flame sealing exposes the surface of the sealant polymer located on the surface to be activated without transferring heat through the entire laminate itself. Heat does not have to travel through the entire package. With open flame sealing, the ability to melt or activate the sealant surface and immediately clamp the surfaces together creates a destruct seal. Termed a go/no go, seal quality classification, a polymer/cellulose seal will either physically tear the paper fiber apart or the seal will separate at the polymer interface creating a seal failure or “no go” measurement.

Open flame sealing temperatures are maintained around 1,500 degrees Fahrenheit. These temperatures far surpass the temperature necessary to activate Autoclave LDPE or Hexane metallocene polymers. Once activated and clamped together the seals cannot be separated without inter-ply delamination in the z direction or inter-ply strength of the cellulose fiber board.

For that reason the quality of a paper cup once sealed together cannot be measured using traditional lbs/inch/grams of force. Instead the paper cup either releases at the polymer interface if the paper cup is poor or the paper separates causing fiber tear if it's an excellent and acceptable seal.

Paper cups have three critical seal regions that will show a poor seal with the naked eye. They are the regions where the upper rim, side seam or bottom seal overlap.

The metallocene sealant surfaces exhibited a lock down perfect rim, side seal and bottom seal in 100% of the cups made from the coated cup stock.

LDPE seals often exhibit flaggers (a top seal that does not stay crimped down at the area where the rim is two ply thick). A liquid package or cup cellulose substrate coated with LDPE simply does not have the inter-ply or film strength that a metallocene hexane polymer has.

The ultimate seal strength for metallocene polymers are plateau type curves. Once the materials are sealed the ultimate seal strength is very uniform and consistent as opposed to an LDPE curve that has a higher and curved initiation temperature and lower ultimate seal strength.

A description of raw materials is as follows:

| | |
|---|---|
| MARFLEX ® 4517 LDPE | An extrusion grade low density |
| | polyethylene resin commercially available |
| | from Chevron Phillips Chemical Company, |
| | LLC. |
| DOW ™ LDPE 5004I | A low density polyethylene resin having a |
| | melt mass flow rate of 4.2 (190° C./2.16 kg) |
| | commercially available from the Dow |
| | Chemical Company. |
| DOWLEX ™ 3010 LDPE | An octane comonomer linear low density |
| | polyethylene resin commercially available |
| | from the Dow Chemical Company. |
| PETROTHENE ® | A low density polyethylene resin |
| NA217000 | commercially available from LyondellBasell. |
| WESTLAKE LDPE | A low density polyethylene resin |
| EC 478 | commercially available from Westlake |
| | Chemical Corporation. |
| LUMICENE ® M3427 | A metallocene polyethylene resin having a |
| | melt index of 3.1 (2.16 kg-190° C.)g/10, |
| | density of 0.934 g/cm³, a melting |
| | temperature of 123° C. and commercially |
| | available from Total Petrochemical. |
| mPE resin BDM2 13-02 | A metallocene polyethylene resin |
| (L727) | having a melt index of 5.0 (2.16 kg- |
| | 190° C.)g/10, density of 0.925 g/cm³, a |
| | melting temperature of 122° C. and |
| | commercially available from KOLM |
| | POLYMERS, LTD of The Woodlands, |
| | Texas. |

TABLE I
PROCESS CONDITIONS

| | |
|---|---|
| Line Speed | 1250 FPM |
| Coat Weight | 10.8 lb/Ream |
| Die Opening | 82″ |
| Total Coat Weight (lb/Ream) | 10.8 lb/Ream = 3/4 mils |

### Example 1

A series of extrusion coating trials were performed to determine the maximum amount of metallocene polymer that could be blended with high pressure LDPE before the neck-in (waste) became unacceptable.

Using a six inch main extruder (A) and a 3.5 inch co-extruder (B) we established that a 50/50 ratio increased the neck-in by 2 inches total or an increase of about 60%. This amount was considered acceptable to the process.

45,000 lineal feet of substrate were processed creating an 18 point SBS substrate with a 10.8 lb/ream polyethylene coating. This is the material caliper and coat weight for a typical sidewall hot cup laminate. Bottom stock would be made using 14 point SBS with the same 10.8 lb/ream polymer coating. The structure was fabricated for hot cups so a coating was applied to the paper side intended for the inside of the container only. The completed sample was:

Clay Coating (smooth print surface)/Substrate/B/A/B (gloss chill roll) coextrusion coating where the B polymer was a blend of 80% metallocene, 20% LDPE; and the A extruder was a blend of 40% metallocene; 60% LDPE.

The BDM2 13-02 (now L727) metallocene improved the heat seal capability of the sealant layer relative to the LDPE both in initiation temperature and ultimate heat seal strength.

Cups were fabricated from the roll stock and relative to the LDPE control sample the performance of the three layer coextrusion cups containing the metallocene far exceeded the LDPE cups using a battery of cup tests. There were zero pin holes in any of the metallocene cups. The upper rim had zero defects and measured 3× stronger in compression tests over LDPE cups. The bottom and side seals exceeded the LDPE cup strength and had zero leaks.

The paper sleeve used by hot coffee cup suppliers serves two purposes. The tapered sleeve supports the cup by transferring the load to the sleeve itself. The sleeve also serves as an additional insulating cellulose layer that slows migration of heat from the cup contents. Other solutions focus on making a multi-wall cup using air as an insulator. Paper handles were attached to the cup to allow the holder to keep from holding a hot cup. Some implementations described herein provide a stronger cup using polyethylene resins that are invisible to the cup forming process. These resins are tailored to: 1. adhere to cellulose substrates in the extrusion coating process; 2. have higher melting points than conventional LDPE used in commercial; 3. use moisture content in the cellulose substrate in combination with proprietary polyethylene coatings on both sides to create air pockets in the outer side of the cup. These air pockets afford a degree of insulation smooth coated cellulose with poly coatings on one or both sides cannot achieve.

Some implementations described herein replace polyethylenes with densities of less than 0.9245 with metallocene LDPE densities greater than 0.9245 to increase the polymer seals resistance to heat once a cup is formed. Further the addition of the metallocene resin strengthens the entire cup by creating fiber tear adhesion seals where two ply and one ply seals meet in the cup's bottom seal and top seal. The economics of this preferred metallocene resin has the potential of adding value while maintaining the current cost structure or reducing it based on reducing top and bottom seal failures. More specifically, “flaggers” which form on the top rim have been eliminated. In addition, leaking bottoms due to poor seals formed adjacent to where two ply cellulose seals are formed next to single ply cellulose seals.

Unlike high pressure autoclave reactors, single site catalyst technology combined with the low pressure slurry loop reactors guarantees a minimum molecular weight chain length is created in the polymer matrix. For the extrusion coating process, a Mn (average molecular weight) polymer chain length of about 23,000 is employed to replace the Mn of 17,000 found in the average high pressure autoclave extrusion coating resin for paperboard coating with a melt index of 5.0 and a density of 0.923 grams/cc. Higher molecular weight averages exhibit higher physical properties as measured in tensile strength at yield, tensile strength at break, elongation, dart drop or impact, tear properties and heat seal strength.

The issue of processability versus post extrusion polymer properties explains the basis for recognizing the significance between the competing resin technologies. Unlike annular or round dies, flat dies have an unsupported extrudate edge. Traditional autoclave resins typically contain a measureable amount of high, average and low molecular weight polymer molecules. Good extrusion coating resins are found to have a broad distribution of polymer molecules. While the low and average polymer molecules comprise the bulk of the polymer it is the Mz or high molecular weight component that is considered responsible for the melt strength that allows for low neck-in and high drawdown capability.

For extrusion coating, melt Index by itself is not a good predictor of processability performance. A second test measuring the strength of the resin in a molten state as it exits the melt index unit at 190 degree Celsius provides the additional data. The melt index strand is pulled at a constant speed of five feet per minute or one inch per second. The strand makes a 180 degree wrap around an idler wheel attached to a strain gauge. The strain gauge records a value in grams. The higher the value the greater the degree of long chain branching. The higher the value the less neck-in a polymer exhibits. Too much melt strength and the extrudate will tear off before it reaches the desired thickness.

Neck-in and drawdown are properties indicative of a polymers molecular weight and molecular weight distribution.

The melt strength exhibited by LUMICENE® technology is uncharacteristic of narrow molecular weight polymers. This discovery created the basis for employing the polymer in a flat die application.

Polyethylene types include homopolymers and copolymers. Melt Index is a single data point expressing a polymers viscosity at 190 degrees Celsius. Lower melt indices are the result of increasing molecular weight. Polyethylene homopolymers molecular weight is inversely related to its melt index. Heat sealing becomes more difficult as melt index decreases. As density increases the melting point of a homopolymer also increases. This also requires sealing conditions to require more time and/or temperature.

By incorporating a second monomer with ethylene the relationship of molecular weight to heat seal strength is no longer a true statement. Commodity comonomer options include butene, hexene and octene. The amount and type of comonomer can have an impact on heat seal strength that is greater than the melt index to molecular weight relationship.

What is proven is the BDM2 13-02 slurry loop product with a hexene comonomer achieves higher ultimate seal strengths than autoclave low density polyethylene.

TABLE II

| | | BDM2 13-02 | LDPE |
|---|---|---|---|
| SIT | 0.77 N/cm | 108.4 | 105.2 |
| | 1.93 N/cm | 111.7 | 108.0 |
| Peak Force | Force | 3.6 | 2.8 |
| | Temp | 115 | 110 |

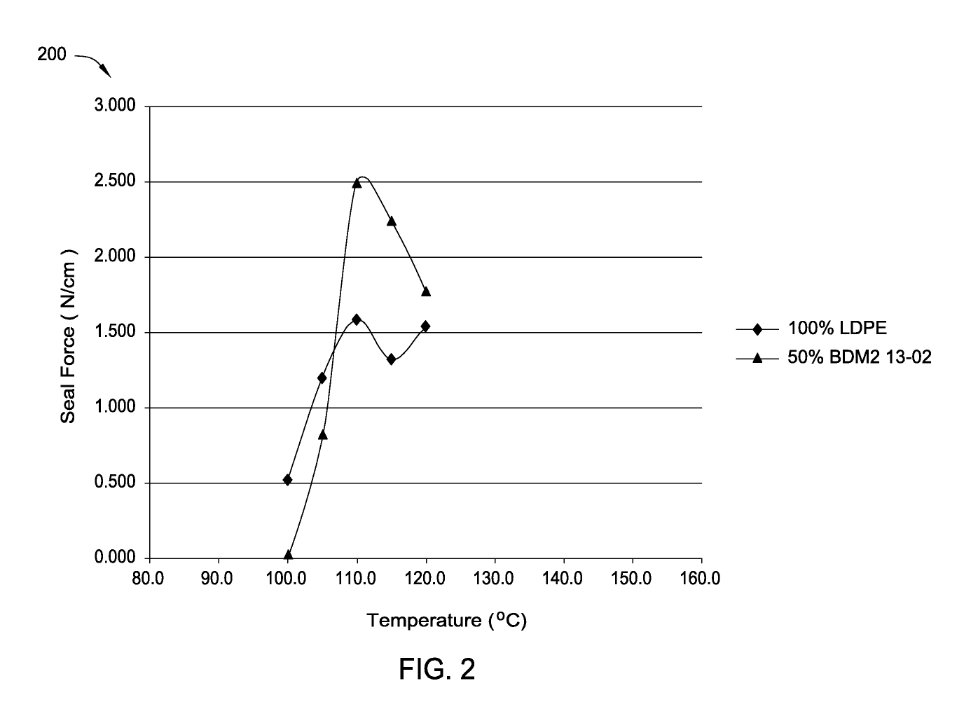

FIG. 2 is a plot 200 depicting the change in seal force as temperature increases for a heat seal of 100% LDPE verses a heat seal produced according to the present disclosure (50% BDM2 13-02).

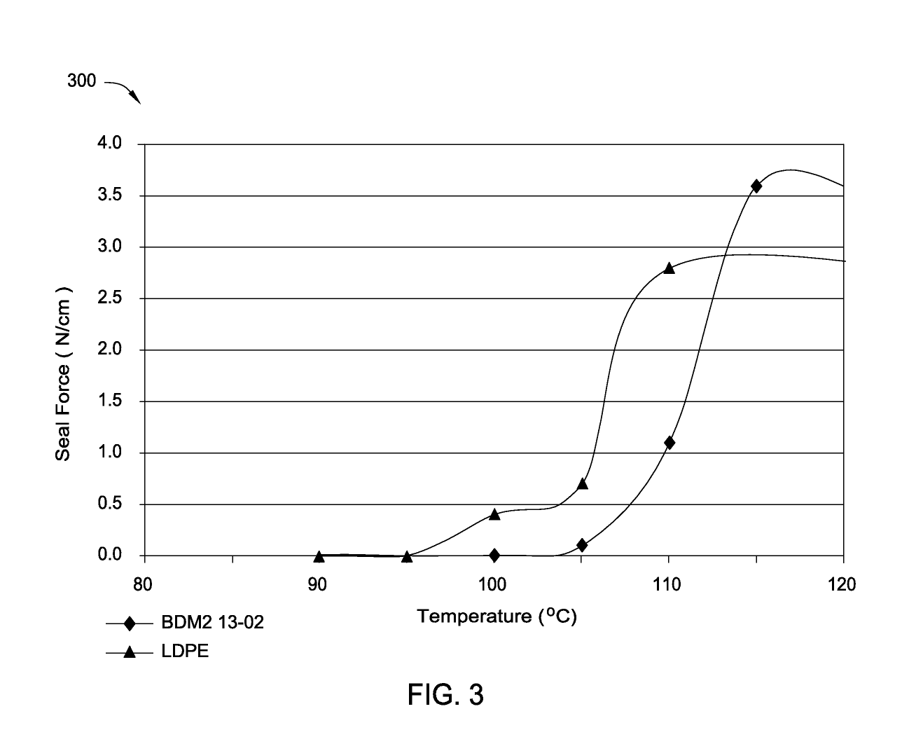

FIG. 3 is another plot 300 depicting the change in seal force as temperature increases for a heat seal composed of LDPE verses a heat seal produced according to the present disclosure;

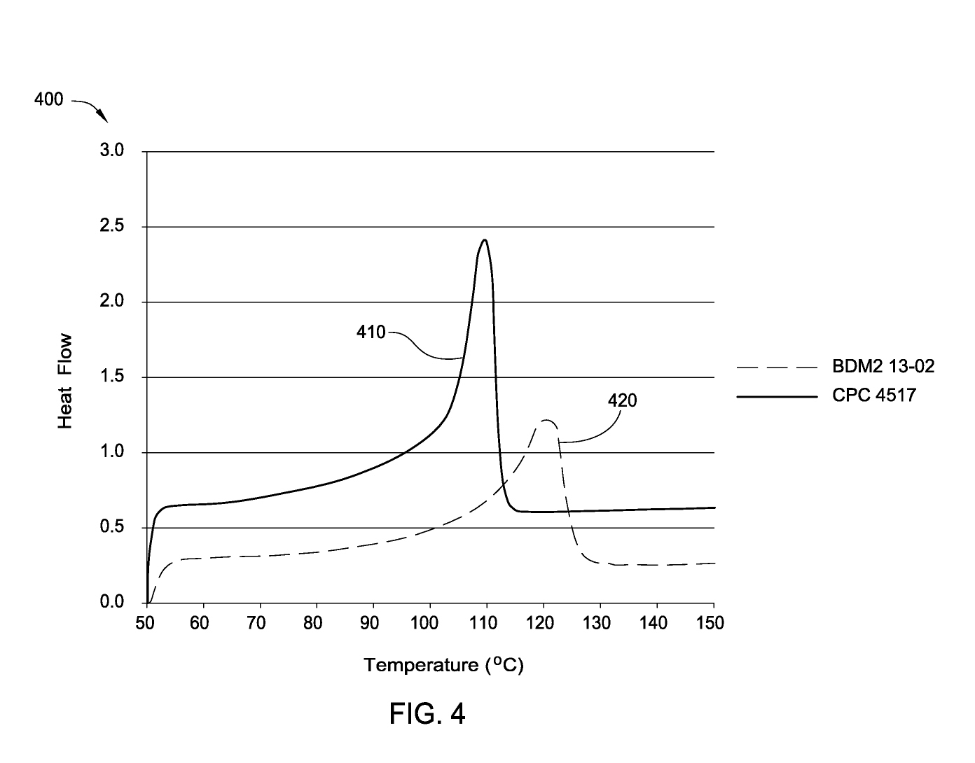

FIG. 4 is a plot 400 depicting differential scanning calorimetry results for a commercially available extrusion coating grade LDPE in comparison with a resin of the present disclosure. Line 410 represents BDM2 13-02 and Line 420 represents MARFLEX® 4517 LDPE.

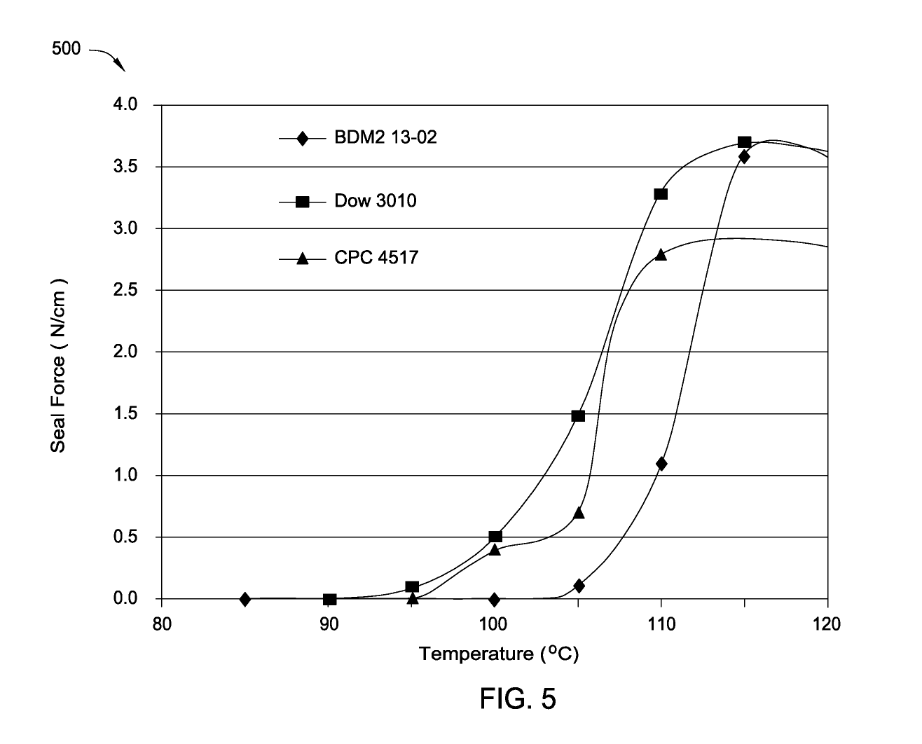

FIG. 5 is another plot 500 depicting the change in seal force as temperature increases for a heat seals composed of commercially available LDPE resins verses a heat seal produced according to the present disclosure.

BDM2 13-02 is manufactured using the low pressure loop slurry process. It was extruded at 680 degrees Fahrenheit and exhibited no color, odor or finished product quality issues. The absence of the low molecular weight tail is evident through OIT analysis (Oxidative Induction Time) analysis. BDM2 13-02 equaled 67 minutes versus 67 seconds for its LDPE autoclave equivalent. Superior WVTR and heat seal strengths, combined with stronger physical strength properties leave no doubt that a better resin for extrusion coating exists outside of the autoclave reactor process.

Table III depicts comparison data for the oxidative induction time (OIT) for BDM2 13-02 in comparison with known LDPE. The Oxidative Induction Time (OIT) is measured as the amount of time before the onset of degradation as measured by DSC. The standard method uses an elevated temperature and simply measures the time delay before the onset of degradation. An alternate method that our lab has developed uses a ramped temperature profile (Temperature Ramp OIT) rather than a constant temperature. We have found this method sometimes provides a more reproducible value especially in cases where the onset of oxidation is slow. The heating rate used in the Temperature Ramp OIT is 2° C./min.

TABLE III

| | LDPE | BDM2 13-02 | |
|---|---|---|---|
| | 5 MI, 0.924 g/cc | D130721523 | D130721527 |
| OIT at | | | |
| Isothermal temperature | | | |
| Average OI Time (min) | 0.6 | 66.8 | 43.9 |
| OI Temp - Air (° C.) | 200 | 200 | 200 |
| Temperature Ramp OIT | | | |
| OI Temp (min) | 19.8 | 36.8 | 33.7 |
| OI Temp (° C.) | 189 | 223 | 217 |

Both tests demonstrate that for standard autoclave LDPE the onset of oxidation takes place rapidly at a temperature of 200° C. (392° F.) while the BDM2 13-02 shows much higher oxidative stability. Based on the ramp test, the onset of oxidation occurs at a much lower temperature, 189° C. (372° F.), than BDM2 13-02, 220° C. (428° F.). Note that these temperatures are not necessarily representative of the performance in extrusion. The test is run in air so there is significant exposure to oxygen. In addition, the time exposure is significantly longer for the test (times are in minutes) compared to extrusion. Consequently, the data simply provides a comparison of the relative thermal stability of the material rather than any guidelines or limitations for extrusion temperatures.

Melt Index is a measurement of the viscosity of the polymer. A Melt Tension measurement of the polymer strand provides a value that correlates with the degree of long chain branching. Like die swell data, Melt tension predicts a resin's ability to drawdown with minimal neck-in. The melt strength equals 6 grams at 190 Celsius for both BDM2 13-02 and equivalent 5 MI autoclave grades. The high melt strength from a linear polymer proves that sufficient long chain branching necessary to process in a flat die is available from a low pressure process resin.

Table IV depicts comparison data for BDM2 13-02 MD, BDM2 13-02 TD, LDPE MD and LDPE TD.

TABLE IV

| | BDM2 13- | | BDM2 13-02 | |
|---|---|---|---|---|
| | 02 MD | LDPE MD | TD | LDPE TD |
| Tensile Strength | 960 | 686 | 1121 | 637 |
| @ Yield | | | | |
| Tensile Strength | 2296 | 1371 | 3242 | 890 |
| @ Break | | | | |
| Elongation @ Yield | 9.4% | 7.9% | 10.55% | 8.1% |
| Elongation @ Break | 401.8% | 142.4% | 575.2% | 232.4% |
| Elmendorf Tear | 91 | 118 | 201 | 48 |

The Dart Drop for BDM2 13-02 was measured at 34 and the dart drop for LDPE was less than 10.

Table V depicts the water vapor transmission rate (WVTR) for 1 mil films of BDM2 13-02 in comparison with two commercially available films. The films were tested using ASTM F1249 at 100 degrees Fahrenheit and 100% RH.

TABLE V

| | |
|---|---|
| BDM2 13-02 | 0.96 grams/100 in²/24 hours |
| DOWLEX ™ 3010 | 1.17 grams/100 in²/24 hours |
| MARFLEX ® 4517 LDPE | 1.11 grams/100 in²/24 hours |

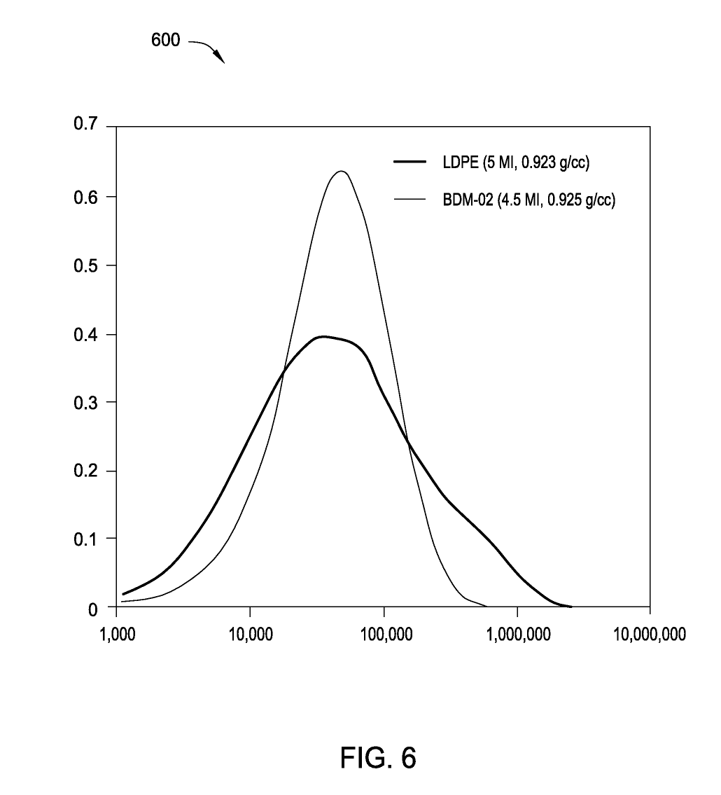

FIG. 6 is another plot 600 depicting the gel permeation chromatography (GPC) molecular weight results a commercially available extrusion coating grade LDPE (5 MI, 0.923 g/cc) in comparison with the resin of the present disclosure (4.5 MI, 0.925 g/cc). BDM2 13-02 is manufactured in such a way that the lowest molecular weight material present in the polymer is controlled to a sufficient length that flavor retention properties are not impacted. As shown in Table VI, comparing BDM2 13-02 which has an average molecular weight of between about 20,000 and about 25,000 (e.g., from about 22,000 and about 24,000; about 23,000) and polydispersity of between 2.0 and 3.0 (e.g., 2.6) to autoclave LDPE which has an average molecular weight of 17,000 and a polydispersity of 6.6 proves that the LDPE has 50% of its polymer chains lower than 17,000. A polymer chain with a molecular weight of less than 300 is in the paraffin and oligomer classification.

TABLE VI

| Value | BDM2 13-02 | LDPE (5MI, 0.923 g/cc) |
|---|---|---|
| Mn | 23,000 | 17,000 |
| Mw | 60,000 | 111,000 |
| Mz | 115,000 | 475,000 |
| PDI | 2.6 | 6.6 |

The low molecular weight tail of BDM2 13-02 is eliminated. Uncoupled distribution of Mw and Mn allows for Mw to be tailored independent of ideal Mn for physical properties and processability. The uniformity of the polymer chains in the BDM2 13-02 resin creates a very uniform crystalline coating. The increased crystallinity is credited to an improvement in Moisture Vapor Transmission Rate (MVTR) of 20% over LDPE 4517.

The MVTR values were between about 0.5 grams/100 inches²/24 hours and 1.0 grams/100 inches²/24 hours (e.g., 0.9 grams/100 inches²/24 hours) for BDM2 13-02 vs. 1.11 grams/100 inches²/24 hours for LDPE 4517. An unanticipated but desirable improvement in the gloss of the BDM2 13-02 coated board was verified to be improved by 20% under duplicate extrusion conditions. Using a 60 degree contact angle gloss test meter, the BDM2 13-02 measured 85, vs. LDPE 4517 value of 60. High Gloss is desirable from an aesthetic packaging property. Consumers are drawn to a package that is superior in surface finishes. The improvement in gloss is attributed to the same uniformity of the crystalline morphology that increased the MVTR properties.

While the foregoing is directed to embodiments of the present disclosure, other and further embodiments of the disclosure may be devised without departing from the basic scope thereof, and the scope thereof is determined by the claims that follow.

1. A rigid paperboard container, the container being constructed from extrusion coated or laminated paperboard comprising:
(a) a paperboard substrate having opposed inner and outer surfaces;
(b) a first polymer layer coated or laminated onto the outer surface of the paperboard substrate, the first polymer layer comprising:
i) a metallocene catalyzed polyethylene polymer; and
ii) optionally low density polyethylene (LDPE);
(c) a second polymer layer coated or laminated over the first polymer layer, the second polymer layer comprising:
i) the metallocene catalyzed polyethylene polymer; and
ii) the LDPE; and
(d) a third polymer layer coated or laminated over the second polymer layer, the third polymer layer comprising:
i) the metallocene catalyzed polyethylene polymer; and
ii) optionally the LDPE.

2. The rigid paperboard container of claim 1, further comprising:
(e) a fourth polymer layer coated or laminated onto the inner surface of the paperboard substrate, the fourth polymer layer comprising:
i) the metallocene catalyzed polyethylene polymer; and
ii) optionally the LDPE;

3. The rigid paperboard container of claim 2, further comprising:
(f) a fifth polymer layer coated or laminated over the fourth polymer layer, the fifth polymer layer comprising:
i) the metallocene catalyzed polyethylene polymer; and
ii) optionally the LDPE; and
(g) a sixth polymer layer coated or laminated over the fifth polymer layer, the fifth polymer layer comprising:
i) the metallocene catalyzed polyethylene polymer; and
ii) optionally the LDPE.

4. The rigid paperboard container of claim 1, wherein the first polymer layer and the third polymer layer each comprise from about 1% to about 100% blend composition percent of the metallocene catalyzed polyethylene polymer and from about 0 to 99% blend composition percent of the LDPE.

5. The rigid paperboard container of claim 3, wherein the second polymer layer comprises from about 1% to about 99% blend composition percent of the metallocene catalyzed polyethylene polymer and from about 1% to about 99% blend composition percent of the LDPE.

6. The rigid paperboard container of claim 5, wherein the first polymer layer and the third polymer layer each comprise from about 70% to about 90% blend composition percent of the metallocene catalyzed polyethylene polymer and from about 10% to about 30% blend composition percent of the LDPE.

7. The rigid paperboard container of claim 6, wherein the second polymer layer comprises from about 50% to about 80% blend composition percent of the metallocene catalyzed polyethylene polymer and from about 20% to about 50% blend composition percent of the LDPE.

8. A method of producing the rigid paperboard container of claim 1, wherein the polymer layers are produced using a coextrusion process.

9. A method of making a rigid paperboard container, comprising:
providing a paperboard substrate having opposed inner and outer surfaces;
depositing a first polymer layer onto the outer surface of the paperboard substrate, wherein the first polymer layer comprises:
i) a metallocene catalyzed polyethylene polymer; and
ii) optionally low density polyethylene (LDPE).

10. The method of claim 9, further comprising:
depositing a second polymer layer onto the first polymer layer, wherein the second polymer layer comprises:
i) the metallocene catalyzed polyethylene polymer; and
ii) the LDPE; and
depositing a third polymer layer onto the second polymer layer, wherein the third polymer layer comprises:
i) the metallocene catalyzed polyethylene polymer; and
ii) optionally the LDPE.

11. The method of claim 10, further comprising:
depositing a fourth polymer layer onto the inner surface of the paperboard substrate, wherein the fourth polymer layer comprises:
i) the metallocene catalyzed polyethylene polymer; and
ii) optionally the LDPE;

12. The method of claim 11, further comprising:
depositing a fifth polymer layer over the fourth polymer layer, wherein the fifth polymer layer comprises:
i) the metallocene catalyzed polyethylene polymer; and
ii) optionally the LDPE; and
depositing a sixth polymer layer over the fifth polymer layer, wherein the fifth polymer layer comprises:
i) the metallocene catalyzed polyethylene polymer; and
ii) optionally the LDPE.

13. The method of claim 9, wherein the first polymer layer is deposited on the paperboard substrate using an extrusion process.
